(19) United States
(12) Patent Application Publication
(10) Pub. No.: US 2017/0161391 A1
(43) Pub. Date: Jun. 8, 2017

(54) METHOD AND ELECTRONIC DEVICE FOR VIDEO RECOMMENDATION

(71) Applicants: Le Holdings (Beijing) Co., Ltd., Beijing (CN); LE SHI INTERNET INFORMATION & TECHNOLOGY CORP.BEIJING, Beijing (CN)

(72) Inventor: Qiang LI, Beijing (CN)

(21) Appl. No.: 15/250,615

(22) Filed: Aug. 29, 2016

Related U.S. Application Data
(63) Continuation of application No. PCT/CN2016/089067, filed on Jul. 7, 2016.

(30) Foreign Application Priority Data
Dec. 8, 2015 (CN) 201510900582.3

(51) Int. Cl. G06F 17/30

(52) U.S. Cl. CPC G06F 17/30867; G06F 17/3079; G06F 17/3082; G06F 17/30858; G06F 17/3084; H04L 67/02

(57) ABSTRACT

Disclosed are a method and an electronic device for video recommendation. The method includes: receiving a video acquisition request of a user; parsing the video acquisition request; searching, according to the parsed video acquisition request, one or more videos categorized according to a preset mapping rule of video categorization, and acquiring one or more videos matching with the parsed video acquisition request, wherein the one more videos come from one or more sources; and recommending the acquired one or more videos matching with the parsed video acquisition request to the user.

### CROSS REFERENCE TO RELATED APPLICATIONS

The present disclosure is a continuation of International Application No. PCT/CN2016/089067, filed on Jul. 7, 2016, which is based upon and priority to Chinese Patent Application No. 201510900582.3 filed on Dec. 8, 2015, the entire contents of all of which are incorporated herein by reference.

### TECHNICAL FIELD

The disclosure relates to the technical field of videos, and more particularly, to a method and electronic device for video recommendation.

### BACKGROUND

The number of video websites is large at present and the users generally jump between various video websites to browse different videos. Since different video categorization criteria are applied on different video websites, the methods for video recommendation employed by the current video websites tail to accurately category the videos, such that the videos recommended by the video websites to the users are cluttered and fail to satisfy users' demands. Therefore, the matching degree with users' requirements is low, and thus effectiveness of video recommendation is poor.

### SUMMARY

An embodiment of the present disclosure provides a method for video recommendation, including:

receiving a video acquisition request of a user;

parsing the video acquisition request;

searching, according to the parsed video acquisition request, one or more videos categorized according to a preset mapping rule of video categorization, and acquiring one or more, videos matching with the parsed video acquisition request, wherein the one more videos come from one or more sources; and

recommending the acquired one or more videos matching with the parsed video acquisition request to the user.

An embodiment of the present disclosure provides an electronic device for video recommendation, including:

at least one processor; and

a memory communicably connected with the at least one processor for storing instructions executable by the at least one processor, wherein execution of the instructions by the at least one processor causes the at least one processor to:

receive and parse a video acquisition request of a user;

store one or more videos categorized according to a preset mapping rule of video categorization, wherein the one or more videos come from one or more video sources;

search, according to the parsed video acquisition request for one or more videos categorized according to a preset mapping rule of video categorization; and

recommend the acquired one or more videos matching with the parsed video acquisition request to the user.

An embodiment of the present disclosure provides a non-transitory computer-readable storage medium storing executable instructions that, when executed by an electronic device, cause the electronic device to:

receive a video acquisition request of a user;

parse the video acquisition request;

search for according to the parsed video acquisition request, one or more videos categorized according to a preset mapping rule of video categorization, and acquire one or more videos matching with the parsed video acquisition request, wherein the one or more videos come from one or more video sources; and

recommend the acquired one or more videos matching with the parsed video acquisition request to the user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for video recommendation scheduling method according to an embodiment of the present disclosure; and

FIG. 2 is a schematic result diagram illustrating an electronic device according for video recommendation to an embodiment the present disclosure;

FIG. 3 is a block diagram of an electronic device used to perform the method for video recommendation according to an embodiment of the present disclosure.

### DETAILED DESCRIPTION

To make the objectives, technical solutions and advantages of the embodiments of the present disclosure clearer the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

For ease of description, in various embodiments of the present disclosure, websites providing videos are referred to as video sources.

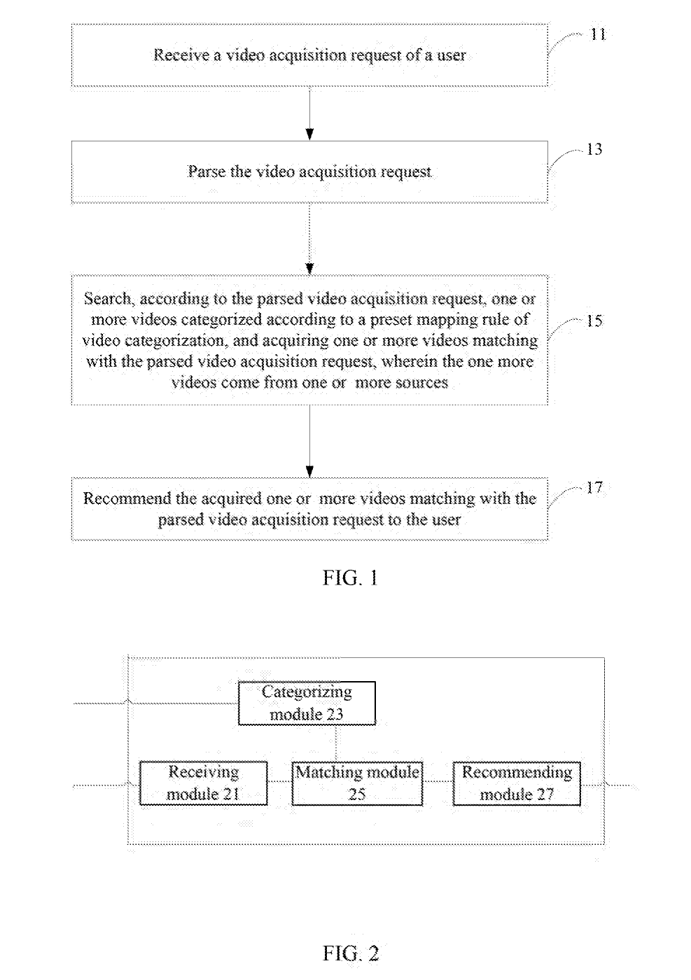

Referring to FIG. 1, an embodiment of the present disclosure provides a method for video recommendation, including:

In step 11: a video acquisition request of a user is received;

In step 13: the video acquisition request is parsed;

In step 15: according to the parsed video acquisition request, one or more videos categorized according to a preset mapping rule of video categorization is searched for, and one or more videos matching with the parsed video acquisition request is acquired, wherein the one or more videos come from one or more video sources; and

In step 17: the acquired one or more videos matching with the parsed video acquisition request to the user is recommended.

With the method and electronic device for video recommendation according to the embodiments of the present disclosure, all the videos coming from various video sources are categorized based on the same mapping rule, and hence these videos from all the video sources are categorized according to the categorization criteria. Therefore, the criteria for categorizing all the videos are normalized, and the categorization criteria of all the video sources are correct. In addition, one or more videos from the video sources may be matched and defined according to a video acquisition request of a user, and the matched one or more videos may be recommended to the user. Accordingly, during recommendation of videos to the user, interests and preferences of the user are fully considered, and therefore effectiveness of video recommendation is high.

Specifically, according to an embodiment of the present disclosure, before one or more videos categorized is searched for according to a preset mapping rule of video categorization, the method further includes steps: the mapping rule is defined; and the one or more videos coming from the one or more video sources is categorized according to the defined mapping rule of video categorization. Categorization of the one or a plurality coming from the one or more video sources according to the predetermined mapping rule for video categorization may be performed in advance, and nevertheless, may also be performed after the user sends the video acquisition request. The specific opportunity for performing the categorization may be determined according to the actual needs.

In an embodiment illustrating the method, for video recommendation according to the present disclosure, the mapping rule includes a correspondence between a video feature and video libraries. The one or more videos coming from the one or more video sources is categorized according to the defined mapping role of video categorization includes: video features of the one or more videos from the one or more video sources is acquired; in the correspondence between a video feature and video libraries in the mapping rule is searched, to acquire video features In a mapping rule matching with the video features of the acquired one or more videos, and a video library corresponding to the matched video features in the mapping rule; and the acquired one or more videos into the corresponding video library is categorized. With the method for video recommendation according to the embodiments of the present disclosure, all the videos coming from various video sources are categorized based on the same mapping rule, and hence these videos from all the video sources are categorized according to the categorization criteria. Therefore, the criteria for categorizing all the videos are normalized, and the categorization criteria of all the video sources are correct. In addition, one or more videos from the video sources may be matched and defined according to a video acquisition request of a users and the matched one or more videos may be recommended to the user. Accordingly, during recommendation of videos to the user, interests and preferences of the user are fully considered, and therefore effectiveness of video recommendation is high.

According to the parsed video acquisition request, one or more videos categorized is searched for according to a preset mapping rule of video categorization, and one or more videos matching with the parsed video acquisition is acquired request includes: in the video library according to the parsed video acquisition request is searched, to acquire one or more videos in a video library corresponding to the parsed video acquisition request; and the recommending the acquired one or more videos matching with the parsed video acquisition request to the user includes: the acquired one or more videos in the video library corresponding to the parsed video acquisition request to the user is recommended.

Specifically, the method further includes: a correspondence table between the video library is stored, a path of the one or more videos in the video library, and the video features of the one or more videos in the video library; the searching in the video library according to the parsed video acquisition request, to acquire one or more videos in a video library corresponding to the parsed video acquisition request includes: according to the parsed video acquisition request, the video feature matching with the parsed video acquisition request in the corresponding table is searched, and path of the video corresponding to the video features matching with the parsed video acquisition request, a path of videos corresponding to the video features matching with the video acquisition request is acquired; and the recommending the acquired one or more videos in the video library corresponding to the parsed video acquisition request to the user includes: the a path of the videos corresponding to the video features matching with the parsed video acquisition request to the user is recommended.

In an embodiment illustrating the method for video recommendation according to the present disclosure, the video acquisition request includes an identifier of the user and a keyword input by the user; the parsing, by the electronic device, the video acquisition request includes; according to the video acquisition request the identifier of the user and the keyword input by the user is acquired; the searching, according to the parsed video acquisition request, the video feature matching with the parsed video acquisition request in the corresponding table, and acquiring path of the video corresponding to the video features matching with the parsed video acquisition request, a path of videos corresponding to the video features matching with the video acquisition request includes; according to the keyword input by the user, in the correspondence table, for video features matching with the keyword input by the user, and acquiring, in the correspondence table according to the searched video features matching with the keyword input by the user, a path of videos corresponding to the video features matching with the keyword input by the user is searched; and the recommending, by the electronic device, the a path of the videos corresponding to the video features matching with the parsed video acquisition request to the user includes: the a path of the videos corresponding to the video features matching with the key word input by the user to the user corresponding to the user identifier is recommended.

Specifically, in an embodiment of the present disclosure, the video library further includes a high quality library and a time effective library, and the mapping rule includes a correspondence between a video feature and quality libraries or time effective libraries, that is, the mapping rule includes a correspondence between a video feature and quality libraries or a correspondence between a video feature and time effective libraries. The categorizing, by the electronic device the one or more videos coming from the one or more video sources according to the defined mapping rule of video categorization includes: video features of the one or more videos from the one or more video sources is acquired; in the correspondence between a video feature and quality libraries or time effective libraries in the mapping rule, to acquire video features in a mapping rule matching with the video features of the acquired one or more videos, and a high quality library or time effective library corresponding to the matched video features in the mapping rule is searched; and the acquired one or more videos into the corresponding quality library or time effective library is categorized. In the embodiment of the present disclosure, the video library includes a high quality library and a time effective library, and different videos are categorized into the quality library and the time effective library respectively according to different video features of the videos. Therefore, the categorization of the videos is more accurate, and thus videos more accommodating the user's requirements may be recommended to the user. Accordingly, video recommendation according to the method for video recommendation of the present disclosure fully considers the requirements of the user, and thus effectiveness of video recommendation is higher.

Specifically, in an embodiment of the present disclosure, the searching for, by the electronic device according to the parsed video acquisition request, one or more videos categorized according to a preset mapping rule of video categorization, and acquiring one or more videos matching with the parsed video acquisition request includes: in the video library according to the parsed video acquisition request, to acquire one or snore videos in a high quality library or time effective library corresponding to the parsed video acquisition request is searched; and the recommending, by the electronic device, the acquired one or more videos matching with the parsed video acquisition request to the user includes: the acquired one or more videos in the quality library or time effective library corresponding to the parsed video acquisition request to the user is recommended.

In an embodiment of the present disclosure, the method may specifically include: a correspondence table between the video library, a path of the one or more videos in the quality library or time effective library, and the video features of the one or more videos in the quality library or time effective library is stored; the searching, by the electronic device, in the video library according to the parsed video acquisition request, to acquire one or more videos in a high quality library or time effective library corresponding to the parsed video acquisition request includes: according to the parsed video acquisition request, the video feature matching with the parsed video acquisition request in the corresponding table, and acquiring path of the video corresponding to the video features matching with the parsed video acquisition request, a path of videos corresponding to the video features matching with the video acquisition request is searched; and the recommending, by the electronic device, the acquired one or more videos in the video library corresponding to the parsed video acquisition request to the user includes: the a path of the videos corresponding to the video features matching with the parsed video acquisition request to the user is recommended.

In the method for video recommendation according to an embodiment of the present disclosure, the video acquisition request includes an Identifier of the user and a keyword input by the user; the parsing, by the electronic device, the video acquisition request includes: according to the video acquisition request, the identifier of the user and the keyword input by the user is acquired; the searching, according to the parsed video acquisition request, the video feature matching with the parsed video acquisition request in the corresponding table, and acquiring path of the video corresponding to the video features matching with the parsed video acquisition request, a path of videos corresponding to the video features matching with the video acquisition request includes: according to the keyword input by the user, in the correspondence table, for video features matching with the keyword input by the user is searched, and in the correspondence table according to the searched video features matching with the keyword input by the user, a path of videos corresponding to the video features matching with the keyword input by the user is acquired, and the recommending, by the electronic device, the a path of the videos corresponding to the video features matching with the parsed video acquisition request to the user includes: the a path of the videos corresponding to the video features matching with the keyword input by the user to the user corresponding to the user identifier is recommended.

In an embodiment of the present disclosure, the quality library and time effective library respectively includes different channels, and the mapping rule includes a correspondence between a video feature and different channels of the quality library or time effective library; and the categorizing, by the electronic device the one or more videos coming from the one or more video sources according to the defined mapping rule of video categorization includes: video features of the one or more videos from the one or more video sources is acquired; in the correspondence between a video feature and different channels of the quality library or time effective library in the mapping rule, to acquire video features on different channels in a high quality library of time effective library matching with the video features of the acquired one or more videos is searched, and different channels in a high quality library or time effective library corresponding to the video features on the different channels in the matched high quality library or time effective library; and the acquired one or more videos into the different channels in the corresponding quality library or time effective library is categorized.

Specifically, in an embodiment of the present disclosure, the searching for, by the electronic device according to the parsed video acquisition request, one or more videos categorized according to a preset mapping rule of video categorization, and acquiring one or more videos matching with the parsed video acquisition request includes: in the video library according to the parsed video acquisition request, to acquire one or more videos in a video library corresponding to the parsed video acquisition request is searched; and the recommending, by the electronic device, the acquired one or more videos matching with the parsed video acquisition request to the user includes: the acquired one or more videos in the video library corresponding to the parsed video acquisition request to the user is recommended.

In an embodiment of the present disclosure, the method may specifically includes: a correspondence table between the different channels in the quality library or time effective library, a path of the one or more videos on the different channels in the quality library or time effective library, and the video features of the one or more videos on the different channels in the quality library or time effective library is stored; the searching, by the electronic device, in the quality library or time effective library according to the parsed video acquisition request to acquire one or more videos in a high quality library or time effective library corresponding to the parsed video acquisition request includes: according to the parsed video acquisition request, the video feature matching with the parsed video acquisition request in the corresponding table and acquiring path of the video corresponding to the video features matching with the parsed video acquisition request, a path of videos corresponding to the video features matching with the video acquisition request is searched, and the recommending, by the electronic device, the acquired one or more videos in the quality library or time effective library corresponding to the parsed video acquisition request to the user includes: the a path of the videos corresponding to the video features matching with the parsed video acquisition request to the user. In the embodiment of the present disclosure, the video library is recommended includes a high quality library and a time effective library, the quality library and the time effective library specifically includes different channels, and different videos are categorized onto different channels in the quality library and the time effective library respectively according to different video features of the videos. Therefore, the categorization of the videos is more accurate and thus videos more accommodating the user's requirements may be recommended to the user. Accordingly, video recommendation according the embodiments of the present disclosure fully considers the requirements of the user, and thus effectiveness of video recommendation is higher.

In the method for video recommendation according to an embodiment of the present disclosure, the video acquisition request includes an identifier of the user and a keyword input by the user; the parsing, by the electronic device, the video acquisition request includes: according to the video acquisition request, the identifier of the user and the keyword input by the user is acquired; the searching, according to the parsed video acquisition request, the video feature matching with the parsed video acquisition request in the corresponding table, and acquiring path of the video corresponding to the video features matching with the parsed video acquisition request, a path of videos corresponding to the video features matching with the video acquisition, request includes: according to the keyword, input by the user, in the correspondence table, for video features matching with the keyword input by the user is searched, and, in the correspondence table according to the searched video features matching with the keyword input by the user is acquired, a path of videos corresponding to the video features matching with the keyword input by the user; and the recommending, by the electronic device, the a path of the videos corresponding to the video features matching with the parsed video acquisition request to the user includes: the a path of the videos corresponding to the video features matching with the keyword input by the user to the user corresponding to the user identifier is recommended. In the embodiment of the present disclosure, when videos are recommended according to the keyword input by the user, user's requirements are fully considered. Therefore, videos recommended to the user are more accurate, user's requirements are better accommodated, and thus effectiveness of video recommendation is higher.

Specifically, in an embodiment of the present disclosure, the method further includes: by the electronic device, preferences of the user according to the identifier of the user is acquired; the searching for, by the electronic device according to the parsed video acquisition request, one or more videos categorized according to a preset mapping rule of video categorization, and acquiring one or more videos matching with the parsed video acquisition request further includes: by the electronic device according to the keyword input by the user and the preferences of the user, the one or more videos categorized according to the predetermined mapping rule for video categorization is searched for, and one or more videos matching with the parsed keyword input by the user and preferences of the user is acquired; and the recommending, by the electronic device, the acquired one or more videos matching with the parsed video acquisition request to the user includes: recommending, by the electronic device, the acquired one or more videos matching with the parsed keyword input by the user and preferences of the user. In the embodiment of the present disclosure, video recommendation also considers preferences of the user, and fully considers user's requirements. Therefore, videos recommended to the user are more accurate, user's requirements are better accommodated, and thus effectiveness of video recommendation is higher.

Specifically, in the method for video recommendation according to an embodiment of the present disclosure, before the recommending, by the electronic device, the acquired one or more videos matching with the parsed video acquisition request to the user, the method further includes: by the electronic device, the one or more videos matching with the parsed video acquisition request based on relevancy is sequenced; and the recommending, by the electronic device, the acquired one or more videos matching with the parsed video acquisition request to the user further includes: by the electronic device, the one or more videos matching with the parsed video acquisition request that are sequenced based on relevancy is recommended. In an embodiment illustrating the method for video recommendation according to the present disclosure, the one or more videos are recommended to the user according to the degrees of relevancy, and user's requirements are considered. Videos which the user is interested in are fully acknowledged. Accordingly, the method for video recommendation according to the embodiments of the present disclosure fully considers user's requirements, and thus effectiveness of video recommendation is high.

Specifically, in the method for video recommendation according to an embodiment of the present disclosure, the method further includes: by the electronic device, machine automatic categorization for the one or more videos from the one or more data sources is performed by means of a machine learning algorithm to acquire one or more videos upon machine automatic categorization; and correcting a categorization result categorized based on the preset mapping rule of video categorization by using a result categorized by means of the machine learning algorithm. In the embodiment of the present disclosure, categorization of the videos is corrected by using a machine learning algorithm, such that categorization of the videos with respect to different video sources is more accurate. Accordingly, during subsequent video recommendation, user's requirements are better accommodated, and thus effectiveness of video recommendation is high.

In an embodiment illustrating the method for video recommendation according to the present disclosure, categorization of the videos from the video sources by using the machine learning, algorithm may be referenced to the following description. Categorization of the videos from the video sources by using the machine learning algorithm may include two steps. In the first step, with respect to each video category, a hatch of categorized videos are acquired as training data, and then a categorization model is acquired according to the training data, wherein the training model represents common features of the video data complying with the category. In the second step, with respect to video data to be categorized, a judgment is made on the video data by using the above categorization model to determine whether the video data complies with the defined common features of the video data of the category and if the video data complies with the defined common features, the video data is automatically placed into the category represented, by the categorization model. For example, a data source, such as Iqiyi, has a video with an incorrect tag, which should be a science and technology tag but is tagged with an entertainment tag, and thus is categorized to the mapping rule “Iqiyi entertainment>Entertainment information” in the embodiment of the present disclosure. Therefore, a mapping is made to the Entertainment information category, which is practically an incorrect mapping. However, according to the machine learning algorithm, although the tag of the data source is made incorrectly, the features of the video still complies with the science and technology model. Therefore, this video may still be placed into the science and technology category by the machine learning algorithm. In this way, the video categories from the categorized video sources are corrected by using the machine learning algorithm.

Specifically, in the method for video recommendation according to an embodiment of the present disclosure, the method further includes: periodically or non-periodically categorizing, by the electronic device, one or more uncategorized videos from the one or more video sources according to the predetermined mapping rule for video categorization; and/or updating one or more categorized videos from the one or more video sources. Due to the increase of videos anytime, uncategorized videos different video sources increase anytime. For accurate and effective video recommendation, uncategorized videos may be periodically or non-periodically categorized according to the mapping rule according to the embodiment of the present disclosure. Nevertheless, with respect to categorized videos, the categorization may also be periodically or non-periodically updated or the mapping rule for reference by the categorization may be refreshed, thereby updating the video categorization. The updated categorization better accommodates the actual needs of the user, and the same categorization criteria are applied to the videos from all the video sources. Accordingly, the categorization criteria applied to the method for video recommendation according to the embodiment of the present disclosure are accurate and normalized, video recommendation fully considers user's requirements, and thus video recommendation is accurate and effective.

The method for video recommendation according to the embodiment of the present disclosure may be applied to such an electronic device as a mobile phone, or may be applied to such an electronic device as a television. For example, Le Super mobile phones have an innovative desk, and this innovative desk is called as negative-1 screen desk, which may be entered by a slide to the left on the main interface. Le products are present on the negative-1 screen desk, and videos are recommended to users in a waterfall manner. Nevertheless, in an embodiment illustrating the method for video recommendation according to the present disclosure, the channels may be sports, news, entertainment, fun and beauties. In addition, different channels pertain to different libraries. For example, fun and beauties channels may pertain to a high quality library, and news and entertainment channels may pertain to a time effective library. In practical applications, with respect to news channels, data thereof may be captured from websites which are updated quickly such as Sina and Iqiyi. With respect to sports and beauties channels, data thereof may be extracted from individualized channels of generally channels, wherein the data may be extracted according to probability.

Videos from various video sources each have their own video features representing their video characteristics, and a path of the videos, and the video features of the video data are extracted, and the extracted video features are subjected to the mapping rule.

Extraction of the video features may be referenced to the following description. When web crawlers of the video features capture videos on various websites, the web crawlers may store all the information that can be acquired. For example, with respect to the following video: http://www.iqiyi.com/v_19rrkanlr8.html#vfrm=2-4-0-1, “Iqiyi homepage>Information” below the title of the video is the breadcrumb of the video, “International” is a tag of the video, and this video is acquired by a jump from the webpage http://list.iqiyi.com/www/25/21740-------------4-1-2-iqiyi-1-.html.

Therefore, the inlink of the video is http://list.iqiyi.com/www/25/21740-------------4-1-2-iqiyi-1-.html. In addition, in the webpage of the inlink, as illustrated the picture, category path thereof is “Information, International”. Various features of such a video would be recorded.

In the method for video recommendation according to the embodiment of the present disclosure, the video features may include, but not limited to, one or a combination of category path, video breadcrumb, video tag, large URL of video website, and inlink URL of video, as long as the video features can represent the characteristics of the videos. Based on the video features captured by the web crawler, different mapping rules may be applied to different websites. For example, some quality large URLs such as Youku release quality videos, and a large URL mapping rule may be applied to Youko. For example, Youku has a large channel “Autohome” and such a mapping rule is established: Youku—Antohome—Automobile”. Still for example, data screened by a combination of breadcrumbs and tags of Iqiyi is relatively accurate, and thus a mapping rule may be generated based on a combination of breadcrumbs and tags, for example. Iqiyi—Iqiyi homepage>Information International—News: International news.

For example, with, respect to the videos corresponding to a video tag “Stock” representing video features in Iqiyi, the corresponding video library may be “Finance”. In this case, the mapping rule may be Iqiyi—Stock—Finance, Stock; and the category upon video categorization may be “Finance, Stock”. Generally a mapping rule is divided into three parts. The first part is the source, for example, Iqiyi; the second part as the feature on the source website, for example, “Stock”; and the third portion is the individualized category upon mapping, for example “Finance, Stock”. These three parts may be spaced apart by using a symbol, for example “—”.

The correspondence there between is mainly implemented by pieces of mapping rules. In addition to the feet as described above that a mapping rule includes three parts, the mapping rule has a flag bit, wherein a flag bit “0” indicates that the video in the mapping rule is placed into the time effective library, and a flag bit “1” indicates that the video in the mapping rule is placed into the quality library.

Still for example, with respect to the videos with the breadcrumb of “NBA homepage. Rockets” representing the video feature in Tencent videos, the corresponding video library may be “Sports, Basketball, NBA”, and the corresponding mapping rule is QQ—NBA homepage, Rockets—Sports, Basketball, NBA; and the corresponding category upon video categorization may be “Sports: Basketball, NBA”.

Still for example, with respect to the videos with the breadcrumb on the Iqiyi website of “Iqiyi homepage, Information”, and the video tag of “International”, the corresponding video library may be “International, News, International News”, and the corresponding mapping rule is: Iqiyi—Iqiyi homepage. Information: International—News, International news; and the category upon video categorization may be “News, International News”.

In a categorization system, the channels corresponding to a video library may include sports, entertainment, fun, news, finance, science and technology, and beauties; wherein the fun, science and technology and beauties channels pertain to the quality library and the remaining channels pertain to the time effective library. The video acquisition request of the user may be originated from a refresh operation performed by the user on a Le product, similar to a refresh operation for Microblog and Today's headlines. In case of a primarily recommended channel, the system may firstly calculates ratios of various categories of videos watched by the user according to the previous clicks and watch records of the user, that is, calculating preferences of the user; and then the system determines final ratios of the categories of videos to be recommended to the user. For example, a user has totally watched five pieces of news, three pieces of entertainment programs and two pieces of beauty programs, totally 10 videos. In this case, if the user performs a refresh operation, in response to a video acquisition request of the user, data at the corresponding ratios is extracted from, an inverted chain of news, entertainment and beauties according to ratios of 5:3:2, and then the extracted data is returned to the user. If the user has further watched a news video, the ratios in a next refresh are respectively changed to 6/11:3/11:2/11. Nevertheless, with respect to a user who initially uses the product, a default ratio is defined for each category.

For the method for video recommendation in the embodiments of the present disclosure, a hardware-based processor may be used to implement related functions thereof. The hardware-based processor may perform the method for video recommendation according to the embodiments of the present disclosure by performing the following operations: receiving a video acquisition request: of a user;

the video acquisition request is parsed;

according to the parsed video acquisition request, one or more videos categorized is searched for according to a preset mapping rule of video categorization, and one or more videos is acquired matching with the parsed video acquisition request, wherein the one or more videos come from one or more video sources; and

the acquired one or more videos matching with the parsed video acquisition request to the user is recommended.

With the method for video recommendation according to the embodiments of the present disclosure is implemented by the hardware-based processor, all the videos coming from various video sources are categorized based on the same mapping rule, and hence these videos from all the video sources ate categorized according to the categorization criteria. Therefore, the criteria for categorizing all the videos are normalized, and the categorization criteria of all the video sources are correct. In addition, one or more videos from the video sources may be matched and defined according to a video acquisition request of a user, and the matched one or more videos may be recommended to the user. Accordingly, during recommendation of videos to the user, interests and preferences of the user are fully considered, and therefore effectiveness of video recommendation is high.

Referring to FIG. 2, an electronic device for video recommendation according to an embodiment of the present disclosure is illustrated. The electronic device includes: a receiving module 21, a categorizing module a matching module 25 and a recommending module 27. The receiving module 21 receives and parses a video acquisition request of a user; the categorizing module 23 stores one or more videos categorized according to a preset mapping rule of video categorization, wherein the one or more videos come from one or more video sources; the matching module 25 searches, according to the parsed video acquisition request, in the categorizing module 23, for one or more videos categorized according to a preset mapping rule of video categorization; and the recommending module 27 recommends the acquired one or more videos matching with the parsed video acquisition request to the user.

With the electronic device for video recommendation according to the embodiments of the present disclosure, all the videos coming from various video sources are categorized based on the same mapping rule, and hence these videos from all the video sources are categorized according to the categorization criteria. Therefore, the criteria for categorizing all the videos are normalized, and the categorization criteria of all the video sources are correct. In addition, one or more videos from the video sources may be matched and defined according to a video acquisition request of a user, and the matched one or more videos may be recommended to the user. Accordingly, during recommendation of videos to the user, interests and preferences of the user are fully considered, and therefore effectiveness of video recommendation is high.

In an embodiment of the present disclosure, the categorizing module 23 searches for one or more videos categorized according to a preset mapping rule of video categorization, define and store the mapping rule, and categorize, the one or more videos coming from the one or more video sources according to the defined mapping rule of video categorization.

In an embodiment of the present disclosure, the mapping rule stored by the categorizing module 23 includes a correspondence between a video feature and video libraries; and specifically, the categorizing, by the categorizing module 23, the one or more videos coming from the one or more video sources according to the defined mapping rule of video categorization includes: acquiring, by the categorizing module 23, video features of the one or more videos from the one or more video sources; searching, by the categorizing module 23, in the correspondence between a video feature and video libraries in the mapping rule, to acquire video features in a mapping rule matching with the video features of the acquired one or more videos, and a video library corresponding to the matched video features in the mapping rule; and categorize, by the categorizing module 23, the acquired one or more videos into the corresponding video library.

In an embodiment of the present disclosure, the searching for, by matching module 25 according to the parsed video acquisition request, one or more videos categorized according to a preset mapping rule of video categorization in the categorizing module 23, and acquiring one or more videos matching with the parsed video acquisition request includes: searching, by the matching module 25, in the video library stored by the categorizing module 23 according to the parsed video acquisition request, to acquire one or more videos in a video library corresponding to the parsed video acquisition request; and the recommending, by recommending module, the acquired one or more videos matching with the parsed video acquisition request to the user includes: recommending, by recommending module 27, the acquired one or more videos its the video library corresponding to the parsed video acquisition request to the user.

In an embodiment of the present disclosure, the matching module 25 stores a correspondence table between the video library, a path of the one or more videos in the video library, and the video features of the one or more videos in the video library; the searching, by the matching module 25, in the video library according to the parsed video acquisition request, to acquire one or more videos in a video library corresponding to the parsed video acquisition request includes: searching, by the matching 25 module according to the parsed video acquisition request, the video feature matching with the parsed video acquisition request in the corresponding table, and acquiring path of the video corresponding to the video features matching with the parsed video acquisition request, a path of videos corresponding to the video features matching with, the video acquisition request; and the recommending, by the recommending module 27, the acquired one or more videos in the video library corresponding to the parsed video acquisition request to the user includes: recommending, by the recommending module 27, the a path of the videos corresponding to the video features matching with the parsed video acquisition request to the user.

In an embodiment of the present disclosure, the video acquisition request includes an identifier of the user and a keyword input by the user; the parsing, by the receiving module 21, the video acquisition request includes: acquiring, by the receiving module 21 according to the video acquisition request, the identifier of the user and the keyword input by the user; the searching, by the matching module 25 according to the parsed video acquisition request, the video feature matching with the parsed video acquisition request in the corresponding table, and acquiring path of the video corresponding to the video features matching with the parsed video acquisition request, a path of videos corresponding to the video features matching with the video acquisition request includes: searching, by the matching module 25 according to the keyword input by the user, in the correspondence table, for video features matching with the keyword input by the user, and acquiring, in the correspondence table according to the searched video features matching with the keyword input by the user, a path of videos corresponding to the video features matching with the keyword input by the user; and the recommending, by the recommending module 27, the a path of the videos corresponding to the video features matching with the parsed video acquisition request to the user includes: recommending, by the recommending module 27, the a path of the videos corresponding to the video features matching with the keyword input by the user to the user corresponding to the user identifier.

In an embodiment of the present disclosure, the video library further includes a high quality library and a time effective library, and the mapping rule includes a correspondence between a video feature and quality libraries or time effective libraries; the categorizing, by the categorizing module 23 the one or more videos coming from the one or more video sources according to the defined mapping rule of video categorization includes: acquiring, by the categorizing module 23, video features of the one or more videos from the one or more video sources; searching, by the categorizing module 23, in the correspondence between a video feature and quality libraries or quality libraries or time effective libraries in the mapping rule, to acquire video features in a high quality library or a time effective library matching with the video features of the acquired one or more videos, and a video library corresponding to the matched video features in the mapping rule; and a high quality library or time effective library corresponding to the video features in the matched high quality library or time effective library; and categorizing, by the categorizing module 23, the acquired one or more videos into the corresponding quality library or time effective library.

In an embodiment of the present disclosure, the searching for, by the matching module 25 according to the parsed video acquisition request; one or more videos categorized according to a preset mapping rule of video categorization, and acquiring one or more videos matching with the parsed video acquisition request further includes: searching, by the matching module 25, in tile video library according to the parsed video acquisition request, to acquire one or more videos in a high quality library or time effective library corresponding to the parsed video acquisition request; and the recommending, by recommending module 27, the acquired one or more videos matching with the parsed video acquisition request to the user includes: recommending, by recommending module, the acquired one or more videos in the quality library or time effective library corresponding to the parsed video acquisition request to the user.

In an embodiment of the present disclosure, the matching module 25 stores a correspondence table between the quality library or time effective library, a path of the one or more videos in the quality library or time effective library, and the video features of the one or more videos in the quality library or time effective library; the searching, by the matching module 25, in the video library according to the parsed video acquisition request, to acquire one or more videos in a video library corresponding to the parsed video acquisition request includes: searching, by the matching 25 module according to the parsed video acquisition request, the video feature matching with the parsed video acquisition request in the corresponding table, and acquiring path of the video corresponding to the video features matching with the passed video acquisition request, a path of videos corresponding to the video features matching with the video acquisition request, and the recommending, by the recommending module 27, the acquired one or more videos in the video library corresponding to the parsed video acquisition request to the user includes: recommending, by the recommending module 27, the a path of the videos corresponding to the video features matching with the parsed video acquisition request to the user.

In an embodiment of the present disclosure, the video acquisition request includes an identifier of the user and a keyword input by the user: the parsing, by the receiving module 21, the video acquisition request includes: acquiring, by the receiving module 21 according to the video acquisition request, the identifier of the user and the keyword input by the user; the searching, by the matching module 25 according to the parsed video acquisition, request, the video feature matching with the parsed video acquisition request in the corresponding table, and acquiring path of the video corresponding to the video features matching with the parsed video acquisition request, a path of videos corresponding to the video features matching with the video acquisition request includes: searching, by the matching module 25 according to the keyword input by the user, in the correspondence table, for video features matching with the keyword input by the user, and acquiring, in the correspondence table according to the searched video features matching with the keyword input by the user, a path of videos corresponding to the video features matching with the keyword input by the user; and the recommending, by the recommending module 27, the a path of the videos corresponding to the video features matching with the parsed video acquisition request to the user includes: recommending, by the recommending module 27, the a path of the videos corresponding to the video features matching with the keyword input by the user to the user corresponding to the user identifier.

In an embodiment of the present disclosure, specifically, the quality library and time effective library respectively include different channels, and the mapping rule includes a correspondence between a video feature and different channels of the quality library or time effective library; and the categorizing, by the categorizing module 23 the one or more videos coming from the one or more video sources according to the defined mapping rule of video categorization includes: acquiring, by the categorizing module 23, video features of the one or more videos from the one or more video sources; searching, by categorizing module 23, in the correspondence between a video feature and different channels of the quality library or time effective library in the mapping rule, to acquire video features on different channels in a high quality library or time effective library matching with the video features of the acquired one or more videos, and different channels in a high quality library or time effective library corresponding to the video features on the different channels in the matched high quality library or time effective library; and categorizing, by the categorizing module 23, the acquired one or more videos into the different channels in the corresponding quality library or time effective library.

In an embodiment of the present disclosure, the searching for, by the matching module 25 according to the parsed video acquisition request, one or more videos categorized according to a preset mapping rule of video categorization, and acquiring one or more videos matching with the parsed video acquisition request further includes: searching, by the matching module 25, in the video library according to the parsed video acquisition request, to acquire one or more videos on different channels in the quality library or time effective library corresponding to the parsed video acquisition request; and the recommending, by the recommending module 27, the acquired one or more videos matching with the parsed video acquisition request to the user includes: recommending, by the recommending module 27, the acquired one or more videos on the different channels in the quality library or time effective library corresponding to the parsed video acquisition request to the user.

In an embodiment of the present disclosure, the matching module 25 stores a correspondence table between the different channels in the quality library or time effective library, a path of the one or more videos on the different channels in the quality library or time effective library, and the video features of the one or more videos on the different channels in the quality library or time effective library; the searching, by the matching module 25, in the quality library or time effective library according to the parsed video acquisition request to acquire one or more videos in a high quality library or time effective library corresponding to the parsed video acquisition request includes: searching, by the matching module 25 according to the parsed video acquisition request, the video feature matching with the parsed video acquisition request in the corresponding table, and acquiring path of the video corresponding to the video features matching with the parsed video acquisition request, a path of videos corresponding to the video features matching with the video acquisition request; and the recommending, by the recommending module 27, the acquired one or more videos in the quality library or time effective library corresponding to the parsed video acquisition request to the user includes: recommending, by the recommending module 27, the a path of the videos corresponding to the video features matching with the parsed video acquisition request to the user.

In an embodiment of the present disclosure, the video acquisition request includes an identifier of the user and a keyword input by the user; the parsing, by the receiving module 21, the video acquisition request includes: acquiring, by the receiving module 21 according to the video acquisition request, the identifier of the user and the keyword input by the user; the searching, by the matching module 25 according to the parsed video acquisition request, the video feature matching with the parsed video acquisition request in the corresponding table, and acquiring path of the video corresponding to the video features matching with the parsed video acquisition request, a path of videos corresponding to the video features matching with the video acquisition request includes; searching, by the matching module 25 according to the keyword input by the user, in the correspondence table, for video features matching with the keyword input by the user; and acquiring, in the correspondence table according to the searched video features matching with the keyword input by the user, a path of videos corresponding to the video features matching with the keyword input by the user; and the recommending, by the recommending module 27, the a path of the videos corresponding to the video features matching with the parsed video acquisition request to the user includes: recommending, by the recommending module 27, the a path of the videos corresponding to the video features matching with the keyword input by the user to the user corresponding to the user identifier.

In an embodiment of the present disclosure, the receiving module 21 acquires preferences of the user according to the identifier of the user; the searching for, by the matching module 25 according to the parsed video acquisition request, one or more videos categorized according to a preset mapping rule of video categorization, and acquiring one or more videos matching with the parsed video acquisition request further includes: searching for, by the matching module 25 according to the keyword input by the user and the preferences of the user, the one or more videos categorized according to the predetermined mapping rule for video categorization, and acquiring one or more videos matching with the parsed keyword input by the user and preferences of the user; and the recommending, by the recommending module 27, the acquired one or more videos matching with the parsed video acquisition request to the user includes: recommending, by the recommending module 27, the acquired one or more videos matching with the parsed keyword input by the user and preferences of the user.

In an embodiment of the present disclosure, before the recommending, by the recommending module 27, the acquired one or more videos matching with the parsed video acquisition request to the user, the recommending module 27 sequences the one or more videos matching with the parsed video acquisition request based on relevancy; and the recommending, by the recommending module 27, the acquired one or more videos matching with the parsed video acquisition request to the user further includes: recommending, by the recommending module 27, the one or more videos matching with the parsed video acquisition request that are sequenced based on relevancy.

In an embodiment of the present disclosure, the matching module 25 performs machine automatic categorization for the one or more videos from the one or more data sources by means of a machine learning algorithm to acquire one or more videos upon machine automatic categorization; and the recommending module 27 corrects, by using a result from categorization by means of the machine learning algorithm, a categorization result from categorization based on the predetermined mapping rule for video categorization.

In an embodiment of the present disclosure, the categorizing module 23 periodically or non-periodically categorizes one or more uncategorized videos from the one or more video sources according to the predetermined mapping rule for video categorization, and/or update one or more categorized videos from the one or more video sources.

Embodiments of the present disclosure further provides a non-transitory computer-readable storage medium storing executable instructions that, when executed by an electronic device with a touch-sensitive display, cause the electronic device to perform any of the embodiments described above of the method for video recommendation.

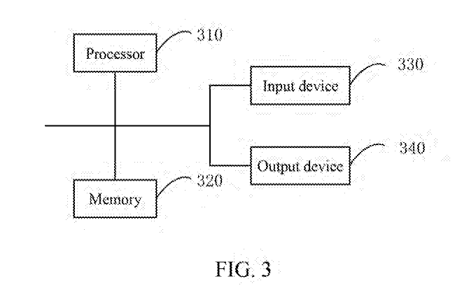

FIG. 3 is a block diagram of an electronic device used to perform the method for video recommendation according to an embodiment of the present disclosure, as shown in FIG. 3, the device includes:

One or more processors 310 and a memory 320, FIG. 3 illustrates one processor 310 as an example.

The device for the method for video recommendation may further include an input device 330 and an output device 340.

The processor 310, the memory 320, the input device 330 and the output device 340 may be connected with each other through bus or other forms of connections. FIG. 3 illustrates bus connection as an example.

As a non-volatile computer-readable storage medium, the memory 320 may be configured to store non-volatile software program, non-volatile computer executable program and modules, such as program instructions/modules corresponding to the method for video recommendation according to the embodiments of the disclosure. By executing the non-volatile software program, instructions and modules stored in the memory 320, the processor 310 may perform various functional disclosures of the server and data processing, that is, the method for video recommendation according to the above mentioned embodiments.

The memory 320 may include a program storage area and a data storage area, wherein, the program storage area may be stored with the operating system and disclosures which are needed by at least one functions, and the data storage area may be stored with data which is created according to use of the device for video recommendation. Further, the memory 320 may include a high-speed random access memory, and may further include non-volatile memory, such as at least one of disk memory device, flash memory device or other types of non-volatile solid state memory device. In some embodiments, optionally, the memory 320 may include memory provided remotely from the processor 310, and such remote memory may be connected with the device for video recommendation through network connections, the examples of the network connections may include but not limited to internet, intranet, LAN (Local Area Network), mobile communication network or combinations thereof.

The input device 330 may receive inputted number or character information, and generate key signal input related to the user settings and functional control of the device for video recommendation. The output device 340 may include a display device such as a display screen.

The above one or more modules may be stored in the memory 320, when these modules are executed by the one or more professors 310, the method for video recommendation according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability; stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

The above described apparatus embodiments are merely for illustration purpose only. The modules which are described as separate components may be physically separated or may be not physically separated, and the components which are illustrated as modules may be or may not be physical modules, that is, the components may be located in the same position or may be distributed into more network modules. A part or all of the modules may be selected according to the actual needs to achieve the objectives of the technical solutions of the embodiments. Persons of ordinary skill in the art may understand and implement the present disclosure without paying any creative effort.

According to the above embodiments of the present disclosure, a person skilled in the art may clearly understand that the embodiments of the present disclosure may be implemented by means of hardware or by means of software plus a necessary general hardware platform. Based on such understanding, portions of the technical solutions of the present disclosure that essentially contribute to the related art may be embodied in the form of a software product, the computer software product maybe stored in a storage medium, such as a ROM/RAM, a magnetic disk, a CD-ROM and the like. Including, several instructions for causing a computer device (a personal computer, a server, or a network device) to perform the various embodiments of the present disclosure, or certain portions of the method of the embodiments.

It should be finally noted that the above-described embodiments are merely for illustration of the present disclosure, but are not intended to limit the present disclosure. Although the present, disclosure is described m detail with reference to these embodiments, a person skilled in the art may also make various modifications to the technical solutions disclosed in the embodiments, or make equivalent replacements to a part of the technical features contained therein. Such modifications or replacement, made without departing from the principles of the present disclosure, shall fall within the scope of the present disclosure.

What is claimed is:

1. A method for video recommendation, comprising: at an electronic device:
receiving a video acquisition request of a user;
parsing the video acquisition request;
searching, according to the parsed video acquisition request, one or more videos categorized according to a preset mapping rule of video categorization, and acquiring one or more videos matching with the parsed video acquisition request, wherein the one more videos come from one or more sources; and
recommending the acquired one or more videos matching with the parsed video acquisition request to the user.

2. The method according to claim 1, wherein
Before searching one or more videos categorized according to a preset mapping rule of video categorization, the method further comprises:
defining the mapping rule; and
categorizing, the one or more videos coming from the one or more video sources according to the defined mapping rule of video categorization.

3. The method according to claim 2, wherein
the mapping rule comprises a correspondence between a video feature and video library; and
the categorizing, the one or more videos comma from the one or more video sources according to the defined mapping rule of video categorization comprises:
acquiring, a video feature of the one or more videos from the one or more video sources;
searching the correspondence between the video feature and the video library in the mapping rule, to acquire a video feature in a mapping rule matching with the video feature of the acquired, one of more videos, and a video library corresponding to the matched video features in the mapping rule; and
categorizing, the acquired one or more videos into the corresponding video library.

4. The method according to claim 3, wherein
the searching, according to the parsed video acquisition request, one or more videos categorized according to a preset mapping rule of video categorization, and acquiring one or more videos matching with the parsed video acquisition request comprises: searching in the video library according to the parsed video acquisition request, to acquire one or more videos in a video library corresponding to the parsed video acquisition request; and
the recommending the acquired one or more videos matching with the parsed video acquisition request to the user comprises, recommending the acquired one or more videos in the video library corresponding to the parsed video acquisition request to the user.

5. The method according to claim 4, further comprising: storing, a correspondence table between the video library, a path of the one or more videos in the video library, and the video feature of the one or more of videos in the video library;
the searching in the video library according to the parsed video acquisition request, to acquire, one or more videos in a video library corresponding to the parsed video acquisition request comprises: searching, according to the parsed video acquisition request, the video feature matching with the parsed video acquisition request in the correspondence table, and acquiring path of a video corresponding to the video feature matching with the video acquisition request in the correspondence table, according to the searched video feature matching with the parsed video acquisition request;
the recommending, the acquired one or more videos in the video library corresponding to the parsed video acquisition request to the user comprises: recommending the path of the video corresponding to the video feature matching with the parsed video acquisition request to the user.

6. The method according to claim 5, wherein
the video requisition request comprises an user identification and a keyword input by the user;
the parsing the video acquisition request comprises: acquiring the user identification, and the keyword input by the user according to the video acquisition request;
the searching, according to the parsed video acquisition request, the video feature matching with the parsed video acquisition request in the correspondence table, and acquiring path of the video corresponding to the video feature matching with the video acquisition request in the correspondence table, according to the searched video feature matching with the parsed video acquisition request comprises: searching, according to the keyword input by the user, the video feature matching with the keyword input by the user in the correspondence table, and acquiring, the path of a video corresponding to the video feature matching with the keyword input by the user in the correspondence table, according to the searched, video feature matching with the key word input by the user; and
the recommending, the path of the video corresponding to the video feature matching with the parsed video acquisition request to the user comprises recommending the path of the videos corresponding to the video feature matching with the keyword input by the user to the user corresponding to the user identification.

7. The method according to claim 3, wherein
the video library further comprises a high quality library and a time effective library, and the mapping rule comprises a correspondence between the video feature and the high quality library or the time effective library;
the categorizing the one or more videos coming from the one or more video sources according to the defined mapping rule of video categorization comprises:
acquiring the video feature of the one or more videos from the one or more video sources;
searching the correspondence between the video feature and the high quality library or the time effective library in the mapping rule, to acquire the video feature in the high quality library of the time effective library matching with the video features of the acquired one or more videos, and the quality library or the time effective library corresponding to the video feature in the matched high quality library or time effective library; and
categorizing, the acquired one or more videos into the corresponding high quality library or time effective library.

8. The method according to claim 1, further comprising:
Acquiring preferences of the user according to the user identification;
the searching, according to the parsed video acquisition request, one or more videos categorized according to the preset mapping rule for video categorization, and acquiring one or more videos matching with the parsed video acquisition request further comprises: searching, according to the keyword input by the user and the preferences of the user, the one or more videos categorized according to the preset mapping rule for video categorization, and acquiring one or more videos matching with the parsed keyword input by the user and preferences of the user; and
the recommending the acquired one or more videos matching with the parsed video acquisition request, to the user comprises: recommending the acquired one or more videos matching with the parsed keyword input by the user and preferences of the user.

9. The method according to claim 1, further comprising: performing machine automatic categorization for the one or more videos from the one or more data sources by means of a machine learning algorithm to acquire one or more videos upon machine automatic categorization; and
correcting a categorization result categorized based on the preset mapping rule of video categorization by using a result categorized by means of the machine learning algorithm.

10. The method according to claim 1, further comprising: periodically or non-periodically categorizing one or more uncategorized videos from the one or more sources according to the preset mapping rule of video categorization; and/or updating one or more categorized videos from the one or more video sources.

11. An electronic device for video recommendation, comprising:
at least one processor; and
a memory communicably connected with the at least one processor for storing instructions executable by the at least one processor, wherein execution of the instructions by the at least one processor causes the at least one processor to:
receive and parse a video acquisition request of a user;
store one or more videos categorized according to a preset mapping rule of video categorization, wherein the one or more videos come from one or more video sources;
search, according to the parsed video acquisition request for one or more videos categorized according to a preset mapping rule of video categorization; and
recommend the acquired one or more videos matching with the parsed video acquisition request to the user.

12. The electronic device according to claim 11, wherein the at least one processor is further caused to:
define the mapping rule; and
categorize the one or more videos coming from the one or more video sources according to the defined mapping rule of video categorization.

13. The electronic device according to claim 12, wherein
The mapping rule comprises a correspondence between a video feature and video library; and
the instructions to categorize, the one or more videos coming from the one or more video sources according to the defined mapping rule of video categorization cause the at least one processor to:
acquire, a video feature of the one or more videos from the one or more video sources;
search the correspondence between the video feature and the video library in the mapping rule, to acquire a video feature in a mapping rule matching with the video feature of the acquired one or more videos, and a video library corresponding to the matched video features in the mapping rule; and
categorize, the acquired one or more videos into the corresponding video library.

14. The electronic device according to claim 13, wherein
the instructions to search, according to the parsed video acquisition request, one or more videos categorized according to a preset mapping rule of video categorization, and acquire one or more videos matching with the parsed video acquisition request cause the at least one processor to: search in the video library according to the parsed video acquisition request, to acquire one or more videos in a video library corresponding to the parsed video acquisition request; and
the instructions to recommend the acquired one or more videos matching with the parsed video acquisition request to the user cause the at least one processor to: recommend the acquired one or more videos in the video library corresponding to the parsed video acquisition request to the user.

15. The electronic device according to claim 14, at least one processor is further caused to: store, a correspondence table between the video library, a path of the one or more videos in the video library, and the video feature of the one or more of videos in the video library;
the instructions to search in the video library according to the parsed video acquisition request, to acquire one or more videos in a video library corresponding to the parsed video acquisition request cause the at least one processor to: search, according to the parsed video acquisition request, the video feature matching with the parsed video acquisition request in the correspondence table, and acquire path of a video corresponding to the video feature matching with the video acquisition request in the correspondence table, according to the searched video feature matching with the parsed video acquisition request;
the instructions to recommend, the acquired one or more videos in the video library corresponding to the parsed video acquisition request to the user cause the at least one processor to: recommend the path of the video corresponding to the video feature matching with the parsed video acquisition request to the user.

16. The electronic device according to claim 15, wherein
the video acquisition request comprises an user identification and a keyword input by the user;
the instructions to parse the video acquisition request cause the at least one processor to: acquire the user identification and the keyword input by the user according to the video acquisition request;
the instructions to search, according to the parsed video acquisition request, the video feature matching with the parsed video acquisition request in the correspondence table, and acquire path of the video corresponding to the video feature matching with the video acquisition request in the correspondence table, according to the searched video feature matching with the parsed video acquisition request cause the at least one processor to: search, according to the keyword input by the user, the video feature matching with the keyword input by the user in the correspondence table, and acquire, the path of a video corresponding to the video feature matching with the keyword input by the user in the correspondence table, according to the searched video feature matching with the keyword input by the user; and
the instructions to recommend, the path of the video corresponding to the video feature matching with the parsed video acquisition request to the user cause the at least one processor to: recommend the path of the videos corresponding to the video feature matching with the keyword input by the user to the user corresponding to the user identification.

17. The electronic device according to claim 13, wherein
the video library further comprises a high quality library and a time effective library, and the mapping rule comprises a correspondence between the video feature and the high quality library or the time effective library;
the instructions to categorize the one or more videos coming from the one or more video sources according to the defined mapping rule of video categorization cause the at least one processor to:
acquire the video feature of the one or more videos from the one or more video sources;
search the correspondence between the video feature and the high quality library or the time effective library in the mapping rule, to acquire the video feature in the high quality library or the time effective library matching with the video features of the acquired one or more videos, and the quality library or the time effective library corresponding to the video feature in the matched high quality library or time effective library; and
categorize, the acquired one or more videos into the corresponding high quality library or time effective library.

18. The electronic device according to claim 11, wherein the at least one processor is further caused to:
acquire preferences of the user according to the user identification;
the instructions to search, according to the parsed video acquisition request, one or more videos category instructions according to the preset mapping rule for video categorization, and acquire one or more videos matching with the parsed video acquisition request further cause the at least one processor to:
search, according to the keyword input by the user and the preferences of the user, the one or more videos categorized according to the preset mapping rule for video categorization, and acquire one or more videos matching with the parsed keyword input by the user and preferences of the user; and
the instructions to recommend the acquired one or more videos matching with the parsed video acquisition request to the user cause the at least one processor to: recommend the acquired one or more videos matching with the parsed keyword input by the user and preferences of the user.

19. The electronic device according to claim 11, wherein, the at least one processor is further caused to: perform machine automatic categorization for the one or more videos from the one or more data sources by means of a machine learning algorithm to acquire one or more videos upon machine automatic categorization; and
correct a categorization result categorized based on the preset mapping rule of video categorization by using a result categorized by means of the machine learning algorithm.

20. The electronic device according to claim 11, wherein, the at least one processor is further caused to: periodically or non-periodically categorize one or more uncategorized videos from the one or more sources according to the preset mapping rule of video categorization; and/or update one or more categorized videos from the one or more video sources.

21. A non-transitory computer-readable storage medium storing executable instructions that, when executed by an electronic device, cause the electronic device to:
receive a video acquisition request of a user;
parse the video acquisition request;
search for according to the parsed video acquisition request, one or more videos categorized according to a preset mapping rule of video categorization, and acquire one or more videos matching with the parsed video acquisition request, wherein the one or more videos come from one or more video sources; and
recommend the acquired one or more videos matching with the parsed video acquisition request to the user.

22. The non-transitory computer-readable storage medium according to claim 21, wherein
before instructions to search one or more videos categorized according to a preset mapping rule of video categorization, the method further caused to:
define the mapping rule; and
categorize, the one or more videos coming from the one or more video sources according to the defined mapping rule of video categorization.

23. The non-transitory computer-readable storage medium according to claim 22, wherein
the instructions to map rule caused to a correspondence between a video feature and video library; and
the instructions to categorize, the one or more videos coming from the one or more video sources according to the defined mapping rule of video categorization cause the at least one processor to:
acquire, a video feature of the one or more videos from the one or more video sources;
search the correspondence between the video feature and the video library in the mapping rule, to acquire a video feature in a mapping rule matching with the video feature of the acquired one or more videos, and a video library corresponding to the matched video features in the mapping rule; and
categorize, the acquired one or more videos into the corresponding video library.

24. The non-transitory computer-readable storage medium according to claim 23, wherein
the instructions to search, according to the parsed video acquisition request, one or more videos categorized according to a preset mapping rule of video categorization, and acquire one or more videos matching with the parsed video acquisition request cause the at least one processor to: search in the video library according to the parsed video acquisition request, to acquire one or more videos in a video library corresponding to the parsed video acquisition request; and
the instructions to recommend the acquired one or more videos matching with the parsed video acquisition request to the user cause the at least one processor to: recommend the acquired one or more videos in the video library corresponding to the parsed video acquisition request to the user.

25. The non-transitory computer-readable storage medium according to claim 24, further caused to: store, a correspondence table between the video library, a path of the one or more videos in the video library, and the video feature of the one or more of videos in the video library;
the instructions to search in the video library according to the parsed video acquisition request, to acquire one or more videos in a video library corresponding to the parsed video acquisition request cause the at least one processor to: search, according to the parsed video acquisition request, the video feature matching with the parsed video acquisition request in the correspondence table, and acquire path of a video corresponding to the video feature matching with the video acquisition request in the correspondence table, according to the searched video feature matching with the parsed video acquisition request;
the instructions to recommend, the acquired cute or more videos in the video library corresponding to the parsed video acquisition request to the user cause the at least one processor to: recommend the path of the video corresponding to the video feature matching with the parsed video acquisition request to the user.
